(19) United States
(12) Patent Application Publication
(10) Pub. No.: US 2008/0084313 A1
(43) Pub. Date: Apr. 10, 2008

(54) Recyclable Anti-Theft Tag

(76) Inventor: Stuart T. Seidel, Boca Raton, FL (US)

Correspondence Address: JOHN C. SMITH, ESQ., 2499 GLADES ROAD, SUITE 113, BOCA RATON, FL, 33431, US

(21) Appl. No.: 11/869,721

(22) Filed: Oct. 9, 2007

Related U.S. Application Data
(60) Provisional application No. 60/828,776, filed on Oct. 10, 2006.

(51) Int. Cl. H04B 7/00

(52) U.S. Cl. 340/572.9

(57) ABSTRACT

A method of recycling a single-use anti-theft tag by adding a concealed aperture to the anti-theft tag housing. A recyclable anti-theft tag that uses a concealed aperture to access a pin locking bar. The pin locking bar is moved from a lockable position to an unlocked position by a detacher arm. A key or probe is inserted into the aperture to return the pin locking bar to the lockable position.

### CROSS-REFERENCE TO RELATED APPLICATIONS

This application is related to, and claims the benefit of, the provisional patent application entitled “Recyclable Anti-Theft Tag”, filed Oct. 10, 2006, bearing U.S. Ser. No. 60/828,776 and naming Stuart T. Seidel, the named inventor herein, as sole inventor, the contents of which is specifically incorporated by reference herein in its entirety.

### BACKGROUND OF THE INVENTION

1. Technical Field

The present invention relates to anti-theft devices which attach to commodities for preventing theft of the commodity. In particular, it relates to a method and apparatus for converting and using a disposable anti-theft tag as a recyclable anti-theft tag.

2. Background

Theft of all kinds has been an ongoing problem for virtually all retail establishments. One kind of theft, shoplifting, has caused substantial damage to retailers due to its widespread use. In an attempt to address this problem, a variety of devices have been developed to limit shoplifting losses by automatically alerting the retailer when an item of merchandise is being illegally removed from the premises.

One type of theft prevention device is the anti-theft tag. An anti-theft tag is typically a small device which can be secured to an item. The anti-theft tag typically includes a tuned circuit or antenna device which communicates with detectors placed at the entrances to the retailer premises. When the detector senses a tag being removed from the store, it alerts the retailer via an alarm that is controlled by the detector.

Anti-theft tags of this type typically contain a first part which holds the tuned circuit or antenna circuitry, along with mechanical methods of securing the first part to a second part which is a securing means. A securing means would typically be a cap-like structure with a securing pin. The securing pin would be pushed through an item, such as a garment, and then secured to the first part. Once a customer has made a purchase, the employee would remove the anti-theft tag so that the customer can take the item out of the store without setting off an alarm. A problem associated with this type of securing pin is that when the anti-theft device is reused, the securing pin is subjected to a certain amount of wear each time it is engaged or disengaged from a commodity. Over time, this gradual damage to the securing pin may reduce its ability to be effectively secured to the first part of the anti-theft device. As a result, it is possible that the securing pin may disengage with relatively little effort on the part of a thief. While it is possible to use a brand new tag every time a commodity is sold, this results in excessive cost.

It would be desirable to structure an anti-theft tag such that the merchant can be sure that it is in proper working order when attached to a commodity, while at the same time providing an anti-theft tag which is inexpensive for both the manufacturer and the merchant.

Another problem that is more important than wear on the locking mechanism is the cost retailers must bear to use anti-theft tags. It would be desirable to provide retailers with anti-theft tag protection at a low cost.

One attempt to make an inexpensive anti-theft tag has been to make them single use disposable tags. These tags have been successful in the sense that they are inexpensive. However, they have also created environmental problems due to the huge numbers of tags that are discarded. It would be desirable to have a method of reusing disposable tags so that the environmental problems they create could be avoided. Further, it would be desirable to have a method of reusing these tags in a manner that would further reduce costs.

In addition to the cost of the anti-theft tags themselves, there is also a substantial cost to the retailer chose related to the amount of time spent installing anti-theft tags when inventory arrives. Typically, store employees would manually attach the anti-theft tags to inventory items when they are delivered to the store. Depending on the size of a delivery, this can take a substantial amount of time and effort. It would be desirable to reduce the amount of time and cost required to install these anti-theft tags on arriving inventory.

While the prior art has provided numerous types of anti-theft tags, it has failed to provide an anti-theft tag structure that allows single-use disposable tags to be reused.

### SUMMARY OF INVENTION

The present invention solves the foregoing problems by providing an anti-theft tag that has a concealed key opening which allows a reset key to be inserted into the tag body to reset the tag to the lockable position. When the anti-theft tag is detached, an aperture that is located under the securing pin is exposed. During use, the aperture is concealed by the securing pin. When the anti-theft device is removed from merchandise, the aperture is exposed. To reset the tag, a key is inserted and rotated to move a pin locking bar from an unlocked to a lockable position. An alternative embodiment allows the pin locking bar to be reset by tapping the edge of the tag.

### BRIEF DESCRIPTION OF DRAWINGS

FIG. 1 is a top view of a prior art disposable tag with the securing pin attached.

FIG. 2 is top view of a prior art disposable tag with the securing pin removed.

FIG. 3 is top view of a prior art disposable tag with the top housing removed and the internal structure exposed.

FIG. 4 is top view of a prior art disposable tag with the top housing removed, the internal structure exposed, the RF antenna removed, and the pin locking bar in the lockable position.

FIG. 5 is top view of a prior art disposable tag with the top housing removed, the internal structure exposed, the RF antenna removed, and the pin locking bar in the unlocked position.

FIG. 6 is top view of a prior art disposable tag with the top housing removed, the internal structure exposed, and the RF antenna, and the pin locking bar removed.

FIG. 7 is top view of a preferred embodiment of a disposable tag design that has been converted to a reusable tag.

### DETAILED DESCRIPTION

Prior to a detailed discussion of the figures, a general overview of the invention will be presented. The goal of the invention is to provide an anti-theft tag that can be recycled for a low cost. The tag will be applied to a commodity item by the clothing manufacturer at the factory. The shipment of goods is then sent by the manufacturer to the retailer with the anti-theft tags pre-attached. This completely eliminates the work, and associated costs, required on the part of the retailer to apply anti-theft tags when inventory shipments are received.

When the commodity item is sold, the retailer will detach the tag in the store in the normal manner. When the tag is detached, the pin locking bar that holds the securing pin is moved to an unlocked position and secured there via a pressure fit, or any other suitable securing means. The tag is preferably returned to the tag manufacturer for reset and recycled used with new inventory. It is envisioned that retailers will be encouraged to return the tags for an incentive, such as a refund. As a result, cost to the retailer will be very low.

When the tag manufacturer receives the anti-theft tags, the securing pin is removed. With the securing pin removed, an aperture is exposed which is normally concealed when the anti-theft tag is attached to inventory. The pin locking bar can be accessed via the aperture that was concealed beneath the securing pin. The anti-theft tag is reset to a lockable position by inserting a key into the aperture and rotating it to move the pin locking bar back to the lockable position.

When the retailers' anti-theft tags are received by the tag manufacturer, the locks are reset and the anti-theft tags are then forwarded to a commodity manufacturer for reattachment to new inventory.

The invention provides a benefit to retailers by reducing the cost they must bear to use anti-theft tags. The single use disposable tag has been converted to a recyclable tag by adding the aperture and using the aperture to access the pin locking bar with a key or probe.

In addition to reducing the retailer cost, a recyclable tag is environmentally friendly, because it eliminates the environmental impact of waste associated with other prior art anti-theft tags, such as disposable tags that would be thrown away after a single use.

Having discussed the invention in general, we turn now to a detailed discussion of the figures.

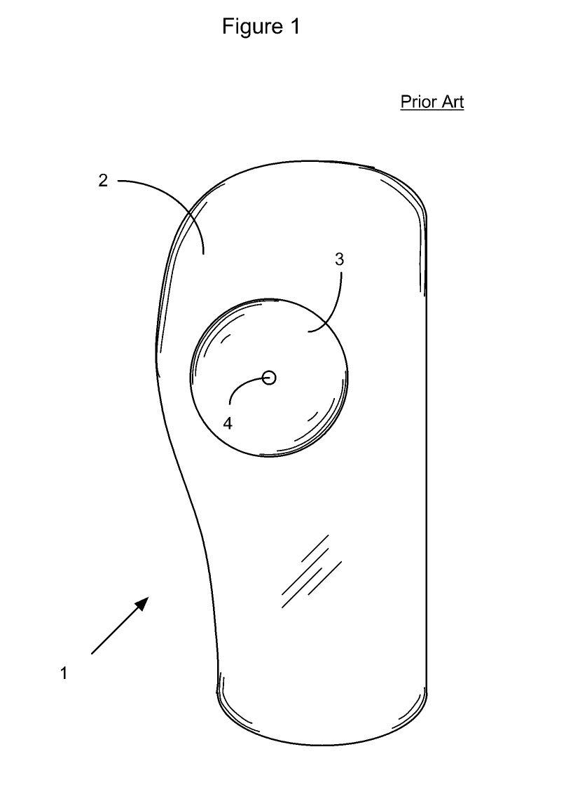

FIG. 1 is a top view of a prior art disposable tag 1 with the securing pin 3 attached. Securing pin 3 has a pin 4 inserted through the top housing 2 of the disposable tag 1.

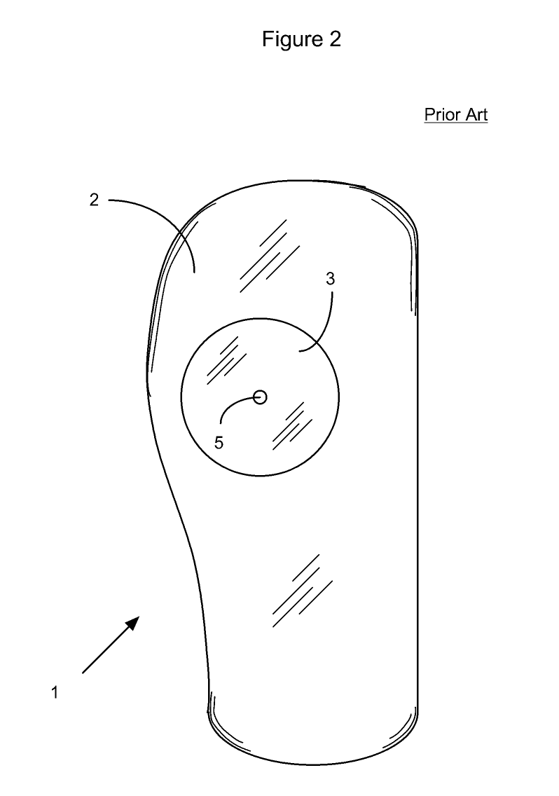

FIG. 2 is top view of a prior art disposable tag 1 with the securing pin 3 removed. A pin aperture 5, which is designed to accept pin 4, is exposed.

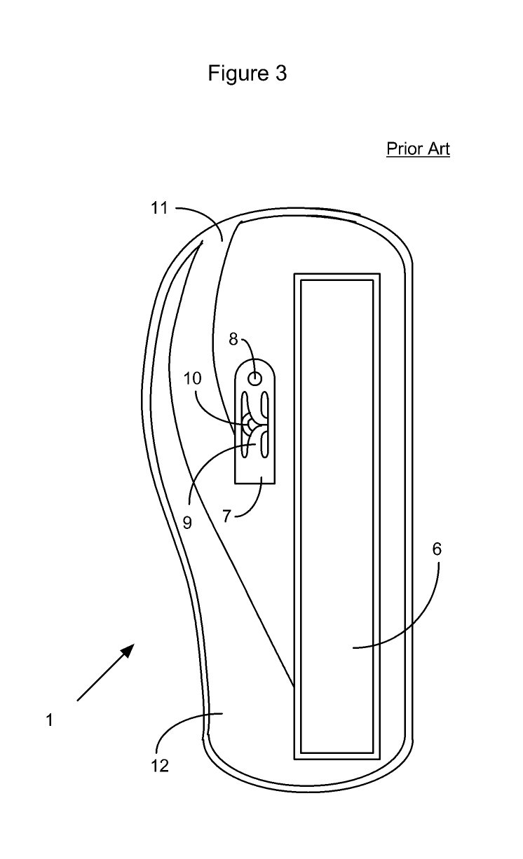

FIG. 3 is top view of a prior art disposable tag 1 with the top housing 2 removed and the bottom housing 12, and internal components exposed. The internal components include the RF antenna 6 and the pin locking bar 7. The pin locking bar 7 is rotatably attached to post 8 on bottom housing 12. Pin channel 10 is shown beneath pin locking par 7. It is positioned to accept pin 4 when the securing pin 3 is attached. In this figure, the pin locking bar 7 is shown in the lockable position. Clips 9 are positioned to grasp pin 4 when it is inserted. Also shown is channel 11, which provides a path for a conventional detaching arm (not shown). Detaching arms are well known in the art and do not need further discussion here. When the detaching arm is inserted, it pushes pin locking arm 7 to the side and releases pin 4.

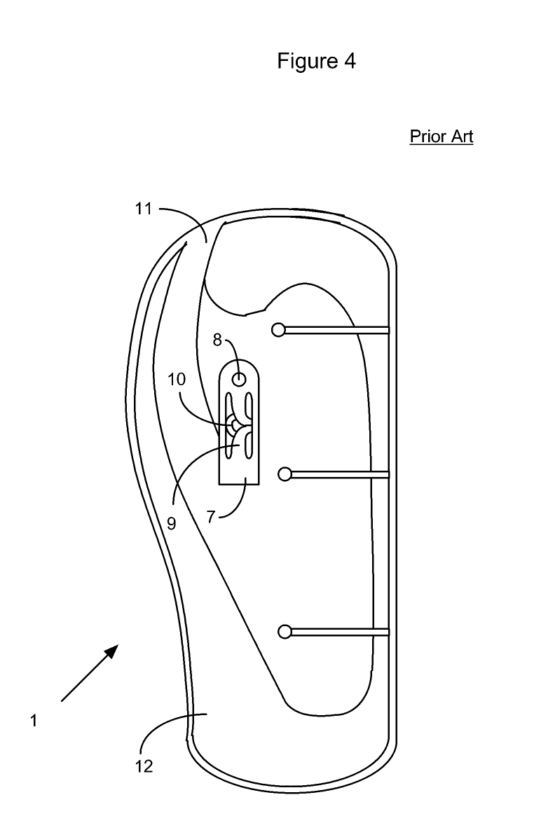

FIG. 4 is top view of a prior art disposable tag 1 with the top housing 2 removed, the internal structure exposed, the RF antenna 6 removed, and the pin locking bar 7 in the lockable position.

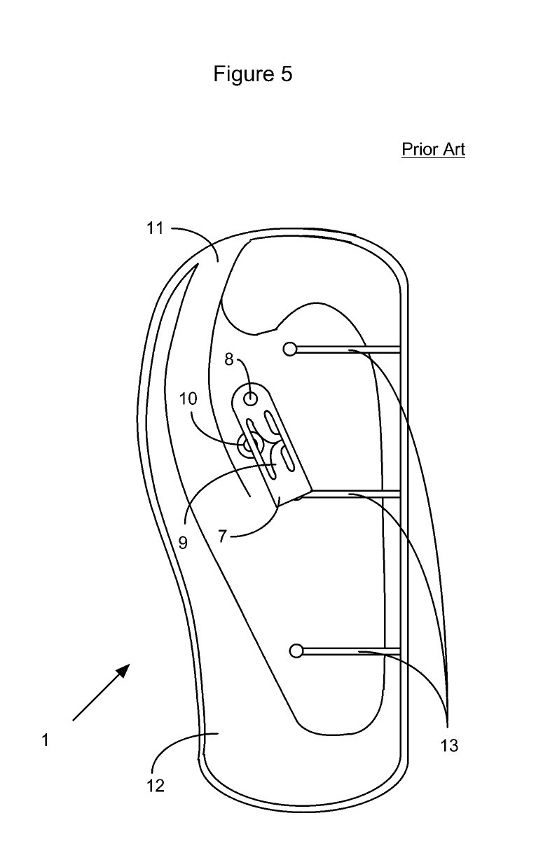

FIG. 5 is top view of a prior art disposable tag 1 with the top housing 2 removed, the internal structure exposed, the RF antenna 6 removed, and the pin locking bar 7 in the unlocked position. In this position the clips 9 are moved to the side and the pin 4 is released. Also shown are pressure rails 13. In the preferred embodiment, top housing 2 and bottom housing 12 have opposing pressure rails 13 which allow pin locking bar 7 to be snugly and movably secured, such that when it is moved to the unlocked position, it remains there.

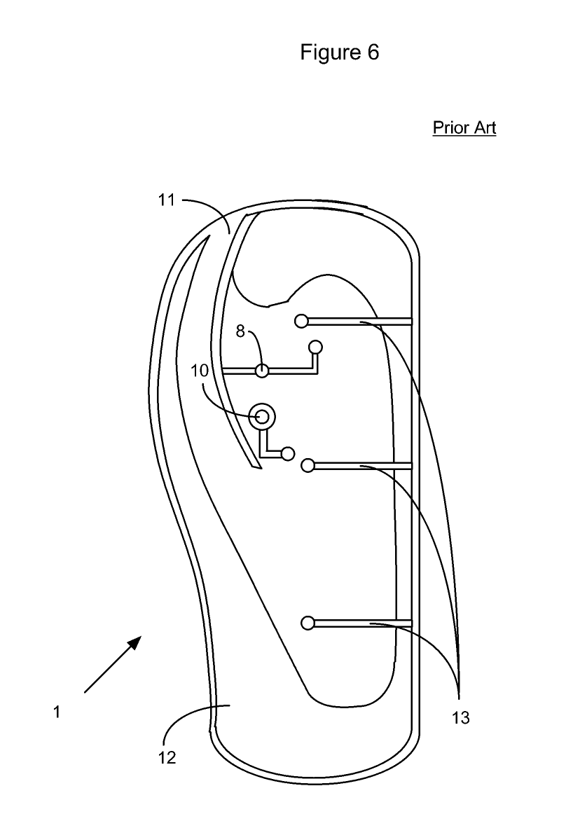

FIG. 6 is top view of a prior art disposable tag 1 with the top housing 2 removed, the internal structure exposed, and the RF antenna 6, and the pin locking bar 7 removed.

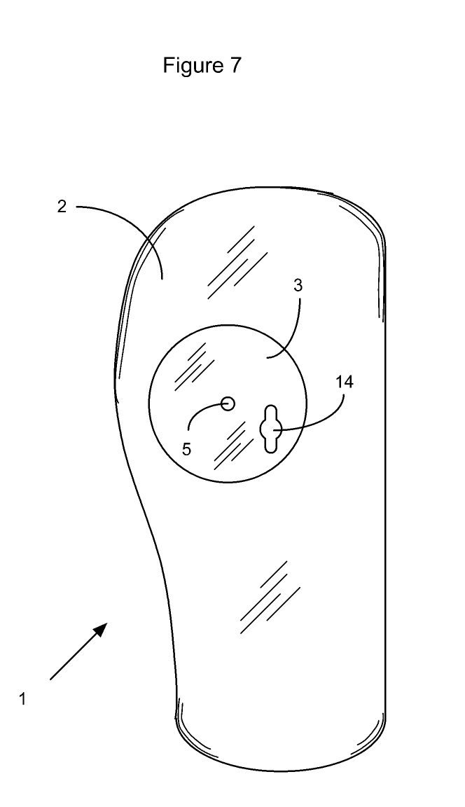

FIG. 7 is top view of a preferred embodiment of a disposable tag 1 design that has been converted to a reusable tag. The invention provides an aperture 14 that is concealed by the securing pin 3 when it is attached. When the tag 1 is unlocked and the securing pin 3 is removed, the tag 1 can be reset to a lockable position by inserting a key or probe (not shown) into the aperture 14 and rotating it to push the pin locking bar 7 back to the lockable position.

An advantage of using aperture 14 is that the pin locking bar 14 can be visibly observed. Alternatively, if pressure rails 13 are properly adjusted, the pin locking bar 7 can be returned to the lockable position by tapping the tag 1 on its side edge to return it to that position.

By using this method, the single use tag 1 can be converted into a reusable tag which will provide substantial cost savings and substantial environmental benefits because of the large number of tags 1 that are used in commerce.

While the invention has been described with respect to a preferred embodiment thereof, it will be understood by those skilled in the art that various changes in detail may be made therein without departing from the spirit, scope, and teaching of the invention. For example, the components key or probe may be anything suitable for their purpose, the size and shape of the anti-theft tag can vary, the securing pin can be a prior art pin, etc. Accordingly, the invention herein disclosed is to be limited only as specified in the following claims. I claim:

What is claimed is:

1. An anti-theft tag, further comprising:
a bottom housing having a pressure rail;
a top housing having a pressure rail;
an aperture in the top housing, the aperture located such that when a securing pin is attached to the antitheft tag, the aperture is concealed beneath the securing pin;
a pin locking bar which pivots between an unlocked and a lockable position; and
the aperture is located such that when the pin locking bar is in the unlocked position, a key or probe inserted into the aperture and rotated will pivot the pin locking bar such that it returns to the lockable position.
